(19) United States
(12) Patent Application Publication
(10) Pub. No.: US 2014/0083087 A1
(43) Pub. Date: Mar. 27, 2014

(54) HYDRAULIC TANK PRESSURIZATION SYSTEM

(71) Applicant: CATERPILLAR INC., Peoria, IL (US)

(72) Inventor: John V. Mount, Washington, IL (US)

(73) Assignee: Caterpillar Inc., Peoria, IL (US)

(21) Appl. No.: 13/628,086

(22) Filed: Sep. 27, 2012

(51) Int. Cl. F16D 31/00

(52) U.S. Cl. 60/327; 60/328

(57) ABSTRACT

A closed loop hydraulic system includes a hydraulic tank, a hydraulic power source, and an air pump. The hydraulic power source is in fluidly coupled to the hydraulic tank to draw the hydraulic fluid from the hydraulic tank. The air pump is in fluid communication with an air space in the hydraulic tank to pressurize the hydraulic tank. Further, a controller configured to receive a pressure signal from a pressure sensor associated with the hydraulic tank and regulate the hydraulic power source and the air pump based on the pressure signal.

### TECHNICAL FIELD

The present disclosure relates to a hydraulic system and more particularly to a hydraulic tank pressurization system in a closed loop hydraulic system.

### BACKGROUND

Earthmoving and construction machines utilize one or more hydraulic actuators to accomplish variety of tasks. These hydraulic actuators are fluidly coupled to a hydraulic tank via a hydraulic power source, for example a pump. The hydraulic tanks commonly have an air space provided therein to compensate for any changes in the volume of hydraulic fluid that occurs during operation. Furthermore, the air space is required to be maintained at a positive pressure at pump inlet.

In high altitude regions, the air pressure in the hydraulic tank may drop below the atmospheric pressure. To overcome this, the hydraulic tanks are elevated with a support structure relative to the machine. In another example, U.S. Pat. No. 3,846,983 discloses a hydraulic tank pressurization arrangement for a closed hydraulic system having a reservoir for containing a variable volume of hydraulic fluid below its full capacity, an internal combustion engine having a forced air intake system providing a source of air under pressure, and a conduit connecting the source of pressurized air with a variable air space in the reservoir.

### SUMMARY

In one aspect, the present disclosure provides a closed loop hydraulic system including a hydraulic tank, a hydraulic power source, and a controller. The hydraulic tank contains a hydraulic fluid such that an expandable air space is defined between the hydraulic fluid and the hydraulic tank. The hydraulic power is fluidly coupled to the hydraulic tank to draw the hydraulic fluid from the hydraulic tank. An air pump may be provided in fluid communication with the air space in the hydraulic tank to pressurize the hydraulic tank. Further, a pressure sensor associated with the hydraulic tank to generate a pressure signal indicative of an air pressure in the hydraulic tank. The controller configured to receive a pressure signal from the pressure sensor and regulate the hydraulic power source and the air pump based on the pressure signal.

Other features and aspects of this disclosure will be apparent from the following description and the accompanying drawings.

### BRIEF DESCRIPTION OF THE DRAWINGS

FIG. 1 illustrates a side view of a machine;

FIG. 2 illustrate a schematic of a hydraulic system associated with the machine of FIG. 1, according to an embodiment of the present disclosure; and

FIG. 3 illustrates a flow diagram of an exemplary method of controlling the hydraulic system of FIG. 2, according to an aspect of the present disclosure.

### DETAILED DESCRIPTION

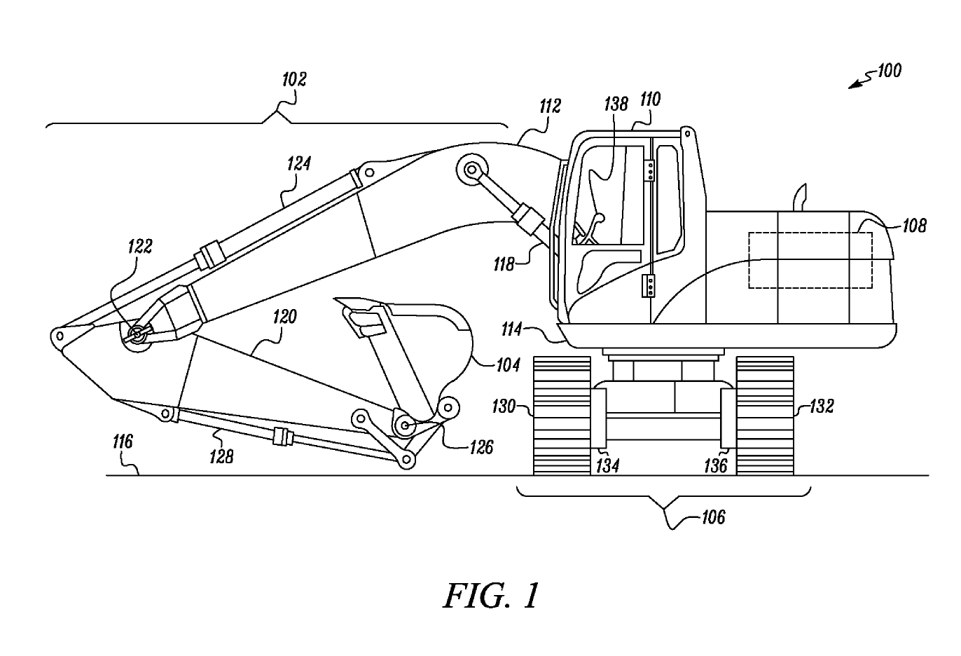

FIG. 1 illustrates a side view of a machine 100, such as a hydraulic excavator, in which various embodiments of the present disclosure may be implemented. The machine 100 may include an implement system 102 configured to move an implement 104, a drive system 106 for propelling the machine 100, a power source 108 that provides power to the implement system 102 and the drive system 106, and an operator station 110 to control the implement 104 and the drive systems 106.

As illustrated in FIG. 1, the implement system 102 may include a boom member 112 pivotally connected to a frame 114 of the machine 100 and configured to vertically pivot about a first horizontal axis (not shown) relative to a ground 116 by a pair of, double-acting, first hydraulic actuators 118 (only one side shown in FIG. 1). The implement system 102 may also include a stick member 120 pivotally connected to the boom member 112 and configured to vertically pivot about a second horizontal axis 122 by a, double-acting, second hydraulic actuator 124. Further, the implement 104 is pivotally connected to the stick member 120 and configured to vertically pivot about a third horizontal axis 126 by a, double-acting, third hydraulic actuator 128.

The drive system 106 may include one or more traction devices to propel the machine 100. In an embodiment, the drive system 106 may include a left side track 130 located on one side of the machine 100, and a right side track 132 located on another side of the machine 100. The left side track 130 may be driven by a left travel motor 134, while the right side track 132 may be driven by a right travel motor 136. The left and the right travel motors 134, 136 may be low speed, high torque type hydraulic motors of any other well-known construction, such as an axial piston motor, a radial piston motor, or a vane type motor. Alternatively, the drive system 106 may include other type of traction devices such as wheels, belts, or other known traction devices.

The power source 108 may embody an engine such as, for example, a diesel engine, a gasoline engine, a gaseous fuel-powered engine, or any other type of combustion engine known in the art. It is contemplated that the power source 108 may alternatively embody a non-combustion source of power such as a fuel cell, a power storage device, or another source known in the art. The power source 108 may produce a mechanical or electrical power output that may be used to pressurize a hydraulic fluid for moving the hydraulic actuators 118, 124, 128 and the left and the right travel motors 134, 136.

The operator station 110 may be configured to receive input, from an operator, indicative of a desired movement of the implement 104 and/or the machine 100. The operator station 110 may include one or more operator interface devices 138, which may be embodied as joysticks. However, it is contemplated that different type of the operator interface devices 138 may alternatively or additionally be included within the operator station 110 such as, for example, knobs, push-pull devices, switches, pedals, touch screens, displays and any other operator interface devices known in the art.

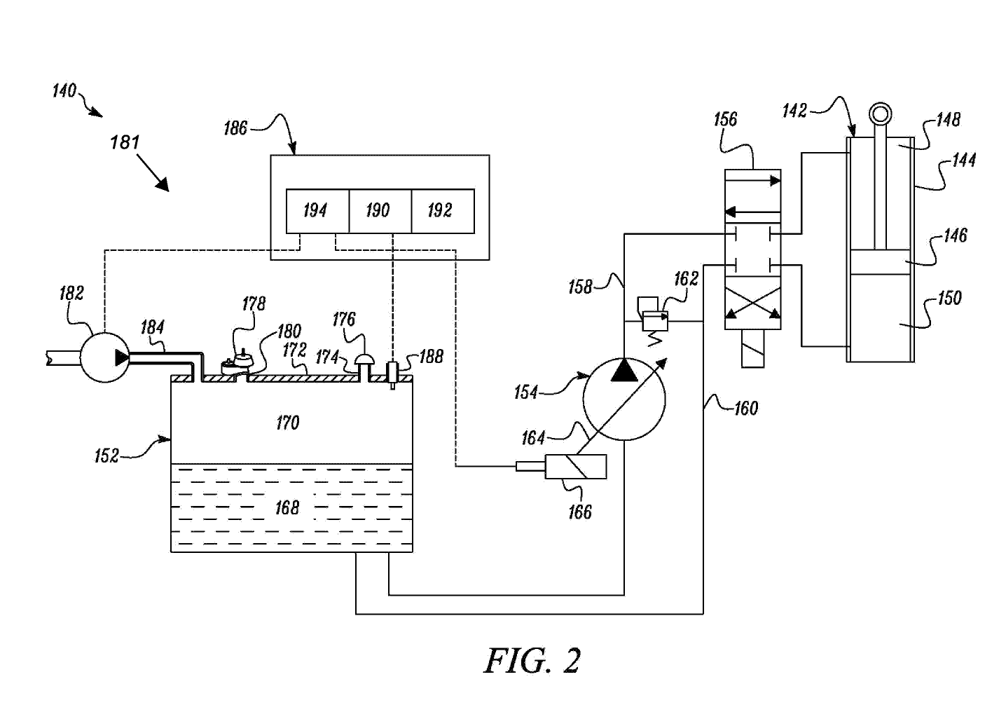

FIG. 2 illustrates a schematic of an exemplary hydraulic system 140 associated with the machine 100. The hydraulic system 140 is configured to move the implement 104 and/or the machine 100 (referring to FIG. 1). As illustrated in FIG. 2, the hydraulic system 140 may be a closed loop hydraulic system and includes a hydraulic actuator 142. The hydraulic actuator 142 may embody one of the first, second, and third hydraulic actuators 118, 124, 128, or the left and the right travel motors 134, 136 configured to move the implement 104 or the machine 100. In the illustrated embodiment, hydraulic actuator 142 includes a cylinder 144 and a piston assembly 146 arranged within the cylinder 144. The piston assembly 146 may divide the cylinder 144 into a first chamber 148 and a second chamber 150. During operation, one of the first and the second chambers 148, 150 may be selectively filled with a pressurized hydraulic fluid and the other drained out to expand or retract the piston assembly 146 relative to the cylinder 144. Thus, an expansion and retraction of the piston assembly 146 may assist in moving the implement 104. Alternatively, the hydraulic actuator 142 may include a hydraulic motor such as the left and the right travel motors 134, 136 which may also be driven by a pressure differential created by the pressurized hydraulic fluid.

The hydraulic system 140 may further include a hydraulic tank 152 and a hydraulic power source 154 fluidly coupled to the hydraulic tank 152. A directional control valve 156 is configured to selectively connect the first chamber 148 and the second chamber 150 of the hydraulic actuator 142 to the hydraulic power source 154 or the hydraulic tank 152. As illustrated, a first conduit 158 is provided between the directional control valve 156 and the hydraulic power source 154 and a second conduit 160 is provided between the directional control valve 156 and the hydraulic tank 152. In an embodiment, a cross-line pressure relief valve 162 may be provided to interconnect the first and the second conduits 158, 160. When the fluid pressure is above a predetermined value, the pressure relief valve 162 is movable to interconnect the first conduit 158 to the second conduit 160 for pressure relief within the first conduit. The first conduit 158 and the second conduit 160 may also include a one-way check valve (not shown) disposed therein to define a one-way flow of the pressurized fluid.

The directional control valve 156 may be solenoid controlled variable four-way valve, movable between three positions. Alternatively, the directional control valve 156 may be actuated by any means known in the art, such as a hydro-mechanical pilot valve, an electro-hydraulic pilot valve, or otherwise. As illustrated, in a first position, the directional control valve 156 may allow the pressurized hydraulic fluid from hydraulic power source 154 to enter the first chamber 148 of the hydraulic actuator 142 via the first conduit 158, and drain out the pressurized hydraulic fluid from the second chamber 150 to the hydraulic tank 152 via the second conduit 160. In a second position, the directional control valve 156 may prevent the pressurized hydraulic fluid from either entering or exiting to the hydraulic actuator 142. In a third position, the directional control valve 156 may allow the pressurized hydraulic fluid from hydraulic power source 154 to enter the second chamber 150 of the hydraulic actuator 142, and drain out the pressurized hydraulic fluid from the first chamber 148 to the hydraulic tank 152. In another embodiment, the directional control valve 156 may include an independent metering valve (IMV) system that includes plurality of independently-operated valves arranged in a wheatstone bridge fashion.

According to an embodiment of the present disclosure, the hydraulic power source 154 may be a variable displacement hydraulic pump of any well known construction and type, such as, a gear pump, a rotary vane pump, a screw pump, an axial piston pump or a radial piston pump. The hydraulic power source 154 may be drivably connected to the power source 108 of machine 100 by, for example, but not limited to, a countershaft, a belt drive, an electrical circuit, or in any other suitable manner. Alternatively, the hydraulic power source 154 may be indirectly connected to the power source 108 via a torque converter, a reduction gear box, or in any other suitable manner. The hydraulic power source 154 may be configured to produce the pressurized hydraulic fluid at different pressure levels and/or flow rates. In an embodiment, the hydraulic power source 154 may include a movable swash plate 164 coupled to a swash plate control valve 166. In an alternative embodiment, the hydraulic power source 154 may be a fixed displacement hydraulic pump.

According to an embodiment of the present disclosure, the hydraulic tank 152 may constitute a reservoir configured to hold a variable volume of a hydraulic fluid 168. The hydraulic fluid 168 may include, for example, a hydraulic oil, an engine lubrication oil, a transmission lubrication oil, or any other fluid known in the art. Generally, the level of the hydraulic fluid 168 is kept below a full capacity of the hydraulic tank 152 such that an inner wall of the hydraulic tank 152 and an upper surface of the hydraulic fluid 168 are structured and arranged to define an expandable variable air space 170 therebetween. The hydraulic tank 152 may further include an upper wall 172 having a filler pipe 174 extending therefrom. A filler cap 176 may be sealably mounted on the filler pipe 174 to maintain airtight sealing of the hydraulic tank 152 to minimize contamination of the hydraulic fluid 168. Further, a vacuum relief valve 178 may be disposed in a conduit 180 connected to the upper wall 172 of the hydraulic tank 152. The vacuum relief valve 178 may be configured to control and limit the air pressure in the hydraulic tank 152 at a pre-determined pressure, and can maintain the air pressure in the hydraulic tank 152 based on the atmospheric pressure. The vacuum relief valve 178 may also be configured to seal the air space 170 within the hydraulic tank 152 in the instance the level of the hydraulic fluid 168 increases as the hydraulic fluid 168 expands due to a temperature increase. In an embodiment of the present disclosure, the vacuum relief valve 178 may be a pilot-operated relief valve.

According to an embodiment of the present disclosure, the hydraulic system 140 may include a hydraulic tank pressurization system 181. The hydraulic tank pressurization system 181 may include an auxiliary air pump 182 in fluid communication with the air space 170 via a manifold 184. The air pump 182 may be configured to supply a flow of pressurized air into the hydraulic tank 152. The air pump 182 may be a positive displacement pump of rotary/reciprocating/linear-movement type construction and also drivably connected to the power source 108 of machine 100. Alternatively, the air pump 182 may be a centrifugal pump of well-known construction.

The hydraulic tank pressurization system 181 may further include a controller 186 to control various components in the hydraulic system 140. According to an embodiment of the present disclosure, the controller 186 may be a programmable logic controller (PLC) configured to receive a pressure signal from a pressure sensor 188. The pressure sensor 188 may be associated with the hydraulic tank 152, such as, for example, being disposed on the upper wall 172 of the hydraulic tank 152. The pressure sensor 188 may be configured to generate the pressure signal, as a voltage or a current signal, based on a variation of the air pressure of the air space 170 in the hydraulic tank 152. The pressure sensor 188 may be a strain gauge, piezoelectric, capacitive, inductive or optical type sensor.

Further, the controller 186 may be electrically coupled to the hydraulic power source 154 and/or the air pump 182. According to an embodiment of the present disclosure, each of the hydraulic power source 154 and the air pump 182 may be configured to receive control signals from the controller 186 based on the pressure signal. In response to the received control signals, each of the hydraulic power source 154 and the air pump 182 may regulate the pressure and/or flow of the pressurized hydraulic fluid from the hydraulic power source 154 and the pressure and/or flow of pressurized air from the air pump 182, respectively.

In an exemplary embodiment, the controller 186 may include a microcomputer, microprocessor, or a programmable logic array (PLA), or the like capable of being programmed. The controller 186 may include a signal input unit 190, a system memory 192, and a processor 194. The signal input unit 190 may be configured to receive a voltage or current signals from the pressure sensor 188 corresponding to the air pressure in the hydraulic tank 152. The system memory 192 may include for example, but not limited to, a Random Access Memory (RAM), a Read Only Memory (ROM), flash memory, a data structure, and the like. The system memory 192 may include a computer executable code to output the one or more control signals based on the pressure signal. The system memory 192 may be operable on the processor 194 to output the control signals to adjust the displacement of the swash plate 164 via the swash plate control 166 of the hydraulic power source 154 and also control the operation of the air pump 182.

In an embodiment, the controller 186 may be incorporated in an engine control module (ECM) associated with the power source 108 of the machine 100. The ECM may be configured to monitor operating conditions of the machine 100, such as, engine speed, engine load. According to an embodiment of the present disclosure, the controller 186 is configured to receive operating conditions of the machine 100 and accordingly control the operation of the hydraulic power source 154 and the air pump 182. Further, the controller 186 may be operatively connected to the operator interface device 138 to provide signals, voltage or current signals, indicative of the air pressure in the hydraulic tank 152. As described above, the operator interface device may embody a display panel configured to produce visual or audible signal in response to the voltage or current signals.

### INDUSTRIAL APPLICABILITY

The industrial applicability of the systems and methods for maintaining the air pressure in the hydraulic tank 152 at a pre-determined pressure described herein will be readily appreciated from the foregoing discussion. Although, in the illustrated embodiment, the machine 100 is embodied as the hydraulic excavator, in various other embodiments, the machine 100 may be, but not limited to, an off-highway truck, on-highway truck, a backhoe loader, an industrial loader, a skidder, a wheel tractor, an excavator, a wheel dozer, an articulated truck, a asphalt paver, a cold planer, a compactor, a motor grader, a hydraulic shovel, or the like. The machine 100 may be a fixed or mobile machine that performs operations associated with an industry such as mining, construction, farming, or any other industry known in the art.

During operation, as the level of the hydraulic fluid 168 changes, due the expansion and retraction of the piston assembly 146 with the cylinder 144, the air pressure in the hydraulic tank 152 may fluctuate. It will be apparent to those skilled in the art that the air pressure in the hydraulic tank 152 may drop below the atmospheric pressure, particularly in high altitude areas, and create a partial vacuum. Under such circumstances, the hydraulic power source 154 may draw in hydraulic fluid 168 from the hydraulic tank 152 against the created partial vacuum. This may cause cavitation of the hydraulic fluid 168 in the hydraulic system 140, particularly in the hydraulic power source 154. Such cavitation creates undesirable noise and also causes an excessive amount of wear to the various components associated with the hydraulic power source 154.

According to an aspect of the present disclosure, the controller 186 may control the operation of the air pump 182 to supply pressurized air in the hydraulic tank 152 and maintain the air pressure at the pre-determined pressure. Moreover, the controller 186 may control the hydraulic power source 154 via the swash plate control valve 166 to limit the displacement of swash plate. Thus, avoiding cavitation and any other undesirable wear to the hydraulic power source 154.

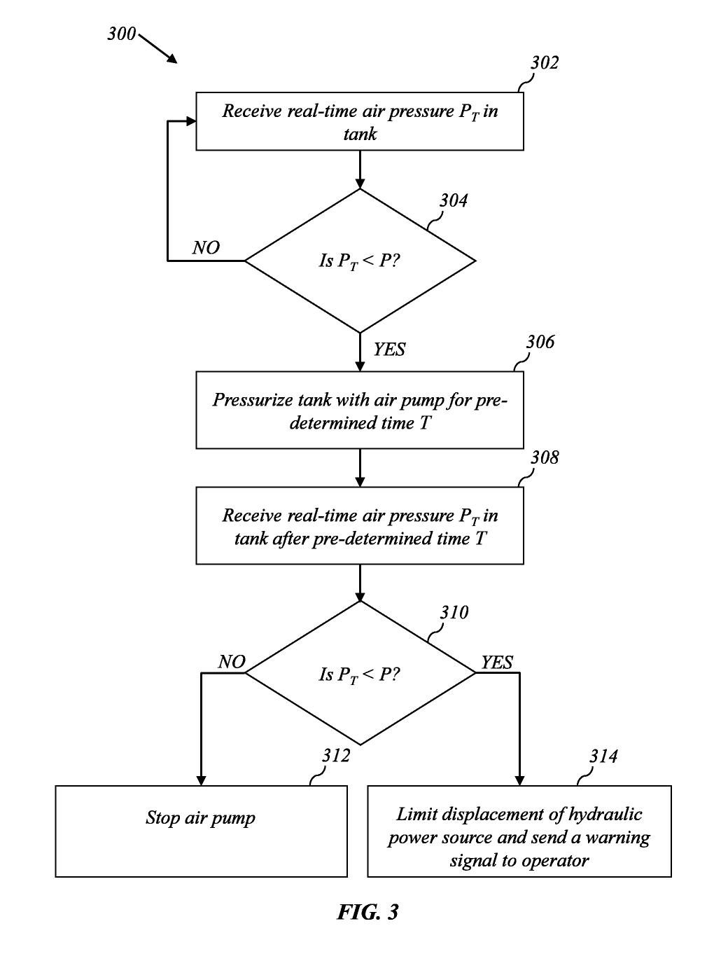

FIG. 3 illustrates a flow diagram of an exemplary method 300 of controlling the hydraulic system 140, according to an aspect of the present disclosure. At step 302 of the method 300, the controller 186 may receive the pressure signal from the pressure sensor 188 which is indicative of a real-time air pressure P_{T} in the hydraulic tank 152. At step 304, the controller 186 is configured to determine whether the real-time air pressure P_{T} is below a pre-determined air pressure P. In an embodiment, the pre-determined air pressure P may range from about 35 kPa to about 120 KPa. When the real-time air pressure P_{T} is not below the pre-determined air pressure P (Step 304: NO), the method 300 can stop or continue by returning to step 302, to receive the pressure signal indicative of the real-time air pressure P_{T} in the hydraulic tank 152.

Moreover, when the real-time air pressure P_{T} is below the pre-determined air pressure P, the partial vacuum may be created within the hydraulic tank 152. This may occur normally in high altitude areas or during the starting conditions of the machine 100. In the illustrated embodiment, if the partial vacuum is created in the hydraulic tank 152 (Step 304: YES), the controller 186 may send the control signal to the air pump 182 to pressurized the hydraulic tank 152 for a pre-determined time period T, at step 306. The pre-determined time period T may be based on a differential of the real-time air pressure P_{T}, and the pre-determined air pressure P. The control signal may energize the air pump 182 during the pre-determined time period T. At step 306, the controller 186 may also limit the displacement of the hydraulic power source 154 via the swash plate control valve 166, such as, for example, destroking a pump, during the pre-determined time period T.

Further, at step 308, the controller 186 may receive the pressure signal from the pressure sensor 188 which is indicative of the real-time air pressure P_{T} in the hydraulic tank 152 after the pre-determined time period T. In the following step 310, the controller 186 may be further configured to determine whether the real-time air pressure P_{T} is below the pre-determined air pressure P. When the real-time air pressure P_{T} is not below the pre-determined air pressure P after the pre-determined time period T (Step 310: NO), the controller 186 may send the control signal to stop the air pump 182, at step 312. Thus, prevents continuous operation of the air pump 182 and prevents failure due to overheating.

However, if the real-time air pressure P_{T} is still below the pre-determined air pressure P after the pre-determined time period T (Step 310: YES), the controller 186 may send the control signal to limit the displacement of the hydraulic power source 154 via the swash plate control valve 166 to partial capacity, such as, for example, about 30% of capacity, at step 314. Furthermore, the controller 186 may send a warning signal to the operator interface device 138 indicative of the partial vacuum in the hydraulic tank 152. Accordingly, the operator may take necessary measures to rectify the problem of the prevailing partial vacuum in the hydraulic tank 152. Moreover, in an instance when a fixed displacement hydraulic pump is are utilized, the controller 186 may only send the warning signal to the operator interface device 138 indicative of the partial vacuum in the hydraulic tank 152.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A hydraulic system comprising:
a hydraulic tank to contain a hydraulic fluid such that an expandable air space is defined between the hydraulic fluid and the hydraulic tank;
a hydraulic power source fluidly coupled to the hydraulic tank to draw the hydraulic fluid from the hydraulic tank;
an air pump in fluid communication with the air space in the hydraulic tank to pressurize the hydraulic tank;
a pressure sensor associated with the hydraulic tank to generate a pressure signal indicative of an air pressure in the hydraulic tank; and
a controller configured to:
receive the pressure signal from the pressure sensor; and
regulate at least one of the hydraulic power source and the air pump based on the pressure signal.

2. The hydraulic system of claim 1, wherein the controller is configured to regulate a flow of pressurized air from the air pump into the hydraulic tank.

3. The hydraulic system of claim 2, wherein the controller is configured to regulate a flow of the hydraulic fluid from the hydraulic power source.

4. The hydraulic system of claim 1, wherein the controller operatively connected to an operator interface device and configured to provide a signal indicative of the air pressure in the hydraulic tank.

5. The hydraulic system of claim 1, wherein the hydraulic power source is a variable displacement hydraulic pump including a swash plate coupled to a swash plate control valve.

6. The hydraulic system of claim 5, wherein the controller configured to output a control signal to adjust the displacement of the swash plate via the swash plate control valve.

7. The hydraulic system of claim 1 further includes a vacuum relief valve associated with the hydraulic tank to control and limit the air pressure in the hydraulic tank.

8. The hydraulic system of claim 1 further including a hydraulic actuator and a directional control valve, the directional control valve is configured to selectively connect the hydraulic actuator with the hydraulic power source or the hydraulic tank.

9. The hydraulic system of claim 8, wherein the directional control valve is a solenoid controlled variable four-way valve.

10. A hydraulic tank pressurization system for a closed loop hydraulic system having a hydraulic tank to contain a hydraulic fluid such that an expandable air space defined between the hydraulic fluid and the hydraulic tank, and a hydraulic power source fluidly coupled to the hydraulic tank to draw the hydraulic fluid from the hydraulic tank, the hydraulic tank pressurization system comprising:
an air pump in fluid communication with the air space in the hydraulic tank to pressurize the hydraulic tank;
a pressure sensor associated with the hydraulic tank to generate a pressure signal indicative of an air pressure in the hydraulic tank; and
a controller configured to receive the pressure signal from the pressure sensor and regulate at least one of the hydraulic power source and the air pump based on the pressure signal.

11. The hydraulic tank pressurization system of claim 10, wherein the controller is configured to regulate a flow of pressurized air from the air pump into the hydraulic tank.

12. The hydraulic tank pressurization system of claim 10, wherein the controller is configured to regulate a flow of the hydraulic fluid from the hydraulic power source.

13. The hydraulic tank pressurization system of claim 10, wherein the controller operatively connected to an operator interface device and configured to provide a signal indicative of the air pressure in the hydraulic tank.

14. The hydraulic tank pressurization system of claim 10, wherein the controller configured to output a control signal to adjust a displacement of the hydraulic power source via a swash plate control valve.

15. The hydraulic tank pressurization system of claim 10 further includes a vacuum relief valve associated with the hydraulic tank to control and limit the air pressure in the tank.

16. A method of controlling a hydraulic system associated with a machine, the method comprising:
receiving a pressure signal from a pressure sensor, the pressure signal being indicative of an air pressure in a hydraulic tank;
determining whether the air pressure is below a pre-determined air pressure; and
pressurizing the hydraulic tank by an air pump for a pre-determined time period when the air pressure is below the pre-determined air pressure.

17. The method of claim 16, wherein the pressure signal is indicative of a real-time air pressure in the hydraulic tank, further including:
receiving a pressure signal from the pressure sensor after the pre-determined time period;
determining whether the real-time air pressure is below the pre-determined air pressure; and
stopping operation of the air pump when the real-time air pressure is equal to or above the pre-determined air pressure after the pre-determined time period.

18. The method of claim 16 further including:
receiving a pressure signal from the pressure sensor after the pre-determined time period;
determining whether the air pressure is below the pre-determined air pressure; and
limiting displacement of a hydraulic power source fluidly coupled to the hydraulic tank when the air pressure is below the pre-determined air pressure after the pre-determined time period.

19. The method of claim 18, wherein the pressure signal is indicative of a real-time air pressure, the limiting displacement of the hydraulic power source including limiting a displacement of the hydraulic power source via a swash plate control valve when the real-time air pressure is below the pre-determined air pressure after the pre-determined time period.

20. The method of claim 19 further including sending a warning signal to an operator interface device when the real-time air pressure is below the pre-determined air pressure after the pre-determined time period.
